(19) United States
(12) Patent Application Publication
(10) Pub. No.: US 2014/0124157 A1
(43) Pub. Date: May 8, 2014

(54) COMPOSITIONS PREPARED FROM AN ALDEHYDE AND A FURFURYL ALCOHOL AND THEIR USE

(71) Applicants: Carlito G. Bangcuyo, Charleston, SC (US); Timothy A. Ropp, Columbus, OH (US); Gregory P. Sturtz, Dublin, OH (US); Joerg Kroker, Powell, OH (US)

(72) Inventors: Carlito G. Bangcuyo, Charleston, SC (US); Timothy A. Ropp, Columbus, OH (US); Gregory P. Sturtz, Dublin, OH (US); Joerg Kroker, Powell, OH (US)

(73) Assignee: ASK CHEMICALS L.P., Wilmington, DE (US)

(21) Appl. No.: 14/127,850

(22) PCT Filed: Jul. 2, 2012
(86) PCT No.: PCT/US2012/045213

§ 371 Date: Dec. 19, 2013

Related U.S. Application Data
(60) Provisional application No. 61/503,927, filed on Jul. 1, 2011.

(51) Int. Cl. C08K 5/1535; B22C 1/10; B22C 9/00

(52) U.S. Cl. CPC C08K 5/1535; B22C 9/00; B22C 1/10
USPC 164/529; 549/502; 549/472; 524/111; 524/109

(57) ABSTRACT

A furfuryl alcohol derivative having the general formula X[—CH(OR)₂]ₘ is prepared by an aldehyde with a furfuryl alcohol in the presence of a copper catalyst. In this formula, X is an aliphatic, cycloaliphatic, aromatic or araliphatic group, R is a 2-furyl group, 2-(5-methylol) furyl group or a mixture thereof, and m is in the range of from 1 to 5. Reaction conditions allow a product having less than 25% free furfuryl alcohol, providing a composition that is suitable as a binder for foundry aggregate in producing a foundry mix.

### CROSS-REFERENCE TO RELATED APPLICATIONS

This application is a non-provisional application of U.S. 61/503,927, filed on 1 Jul. 2011, and makes a claim of priority to that application, which is incorporated by reference as if fully recited herein.

### TECHNICAL FIELD

The invention disclosed herein relates generally to compositions prepared from an aldehyde and furfuryl alcohol, and, more particularly, to such compositions and their use in the casting of metal articles.

### BACKGROUND

Molds and cores used in the casting of metal articles can be made from a foundry aggregate and a foundry binder. In the “no-bake” process, a foundry mix is prepared by mixing an appropriate aggregate with the binder and a curing catalyst. After forcing the foundry mix into a pattern, the curing of the foundry mix provides a foundry shape useful as a mold or core. In the “cold box” process, a foundry mix is prepared by mixing an appropriate aggregate with a binder. After forcing the foundry mix into a pattern, a catalyst vapor is passed through the foundry mix, causing it to cure and provide a foundry shape useful as a mol or core. In another process, the foundry mix is prepared by mixing the aggregate with a heat reactive binder and catalyst. The foundry mix is shaped by forcing it into a heated pattern that causes the foundry mix to cure, providing a foundry shape useful as a mold or core.

Some of the more widely used binders in the foundry industry for the no-bake and heat cured processes are phenol-formaldehyde (“PF”) binders and furfuryl alcohol (“FA”) binders. Both phenol-formaldehyde binders and furfuryl alcohol binders are used in a wide variety of foundry binder formulations. Each specific foundry binder formulation has characteristic advantages and disadvantages. This wide variety of formulations makes it possible for the foundry to choose the specific type of foundry binder which is best suited to their particular casting manufacturing operation. Some examples of foundry binders based on PF and FA binders are furan no-bake binders, furan hot box binders, furan warm box binders, PF no-bake binders, PF hot box binders, phenolic urethane no-bake binders, ester cured phenolic no-bake binders, phenolic urethane cold-box binders and FA-sulfur dioxide cold-box binders.

While PF and FA foundry binders are among the most popular in the industry, the current technology presents some challenges. A first issue is the high viscosity of the PF and FA polymers used for foundry binders. High viscosity makes handling the binders and mixing the binders on foundry aggregates difficult. The “high viscosity” problem is often addressed by using water or organic solvents to dilute and thin the binders. While lowering viscosity, the diluents can deteriorate the aggregate binding strength. In addition, the use of these diluents, especially the organic diluents, can increase the volatile organic carbon (“VOC”) content of the binder and increase the odors generated during core and mold making as well as pouring, cooling and shake out of the casting. Furthermore, these diluents can contain hazardous air pollutants which can be released to the environment.

A second issue posed by the current technology is the residual raw material that remains in the PF and FA binders. Unreacted monomers that can be present in the binders include phenol, formaldehyde and furfuryl alcohol. Exposure to any of these monomers while preparing or using the foundry binders can cause health related problems to foundry workers. These components are all of industrial hygiene concern and the exposure of workers to them is subject to regulation.

A third issue with current PF and FA binders is that many of them have limited storage or shelf life. PF and FA binders can continue to polymerize and thicken upon storage, especially at elevated temperatures. This binder thickening can proceed to a point that the viscosity is so high that transfer, pumping and mixing on foundry aggregate can become impossible.

It is clear that there are advantages and disadvantages to using current PF and FA based binders in the no-bake, and heat cured processes for core and mold making. In addition it is obvious that there is a need for improved binders possessing the same advantages of PF and FA binders, while addressing the known disadvantages.

It is therefore an object of this invention to provide an improved binder for use in producing foundry shapes that provides as many of the advantages as possible of the known PF and FA based binders, while minimizing or, preferably, eliminating, the known disadvantages.

### SUMMARY

These and other advantages are provided by a composition having the formula X[—CH(OR)₂]ₘ, wherein:
R is a 2-furyl group, 2-(5-methylol) furyl group or a mixture thereof,
m is in the range of from 1 to 5, and
X is an aliphatic, cycloaliphatic, aromatic or araliphatic group.

The composition is manufactured by a that comprises the step of reacting furfuryl alcohol with an aldehyde in the presence of a copper catalyst.

The process is carried out under conditions of dynamic covalent chemistry such that the composition contains less than 25 percent by weight of free furfuryl alcohol.

In some aspects of the invention, the process is carried out with the aldehyde being reacted with the furfuryl alcohol in an equivalent ratio in the range of from 4:1 to 8:1 molar equivalents.

In some aspects, the copper catalyst is copper(II) tetrafluoroborate, copper chloride and mixtures thereof.

In some aspects, the aldehyde is a monoaldehyde or a dialdehyde, although some aspects are achieved using a polyaldehyde, such as poly(aldehyde guluronate).

In some aspects of the invention, the composition is used to form a foundry mix that comprises the composition used as a binder for a major amount of foundry aggregate.

In some embodiments, the foundry mix also comprises a liquid curing catalyst, preferably selected from the group consisting of copper chloride, copper toluene sulphonate, aluminum phenol sulphonate, phenol sulphonic acid, p-toluene sulphonic acid, lactic acid, benzene sulfonic acid, xylene sulfonic acid, sulfuric acid, salts thereof and mixtures thereof. In many of these embodiments, the liquid curing catalyst is present in an amount from about 1 to 60 weight percent, based upon the weight of the binder.

A foundry mix of this type without the liquid curing catalyst can be used in a “cold box” process to produce a formed and cured foundry shape for the casting of metal parts.

A foundry mix of this type, with the liquid curing catalyst included, can be used in a “no bake” process or a “hot box” process to produce a formed and cured foundry shape for the casting of metal parts.

### DETAILED DESCRIPTION

In one aspect of the invention, the advantages are achieved by a composition prepared by reacting a furfuryl alcohol with an aldehyde to provide a furfuryl alcohol derivative (“FAD”) product having the general formula:

X[—CH(OR)₂]ₘ (A)

where X is an aliphatic, cycloaliphatic, aromatic or araliphatic group, R is a 2-furyl group, 2-(5-methylol) furyl group or a mixture thereof, and m is in the range of 1 to 5. As will be shown, the FAD product has usefulness as a binder.

This aspect of the invention also relates to the FAD product having the structural formula (A) that is prepared by conducting the reaction in the presence of a copper catalyst.

A composition made up of the FAD product having the structural formula (A) is useful in preparing foundry shapes using known processes. To prepare a foundry mix, a composition comprising FAD product is mixed with a major amount of a foundry aggregate and an appropriate curing catalyst. The resulting foundry mix is then shaped into molds or cores by introducing it into a pattern, preferably a heated pattern when a warm-box or hot-box process is applied. The molds and cores are used to make cast metal parts.

Compositions of the FAD product have several advantages. As binders, they are sufficiently reactive so that the catalyst level and/or “furfuryl alcohol binder performance enhancing component” can be reduced. Furthermore, the FAD product can be synthesized such that the free furfuryl alcohol (CAS RN 98-00-0) in the binder composition will be below 25%, yet a desired reactivity and viscosity are maintained. Compositions comprising the FAD product also display greater product stability when compared to the PF or FA compositions since compositions of the FAD product contain no free reactive species like formaldehyde (CAS RN 50-00-0).

One surprising property of compositions comprising the FAD product are the low viscosities, when compared to the known PF and FA binders.

As described in U.S. Pat. No. 7,713,955, issued to Whiteford, the term “Dynamic Covalent Chemistry” (DCC) is attributed to the article by that name by Rowan, S. J. et al., published in Angew Chem Int Ed Engl., 2002, Vol. 41, No. 6, pp 898-952. The term DCC refers to chemical reactions conducted reversibly under conditions of equilibrium control. The reversible nature of the reactions introduces the prospects of “error checking” and “proof-reading” into synthetic processes where DCC operates. Since the products are formed under thermodynamic control, the product distributions depend only on the relative stabilities of the final products. In kinetically controlled reactions, however, it is the free energy differences between the transition states that lead to the products which determine their relative proportions. Supramolecular chemistry has had a huge impact on synthesis at two levels: one is noncovalent synthesis, or strict self-assembly, and the other is supramolecular assistance to molecular synthesis, also referred to as self-assembly followed by covalent modification. Noncovalent synthesis has provided access to finite supermolecules and infinite supramolecular arrays. Supramolecular assistance to covalent synthesis has been exploited in the construction of more-complex systems, such as interlocked molecular compounds (for example, catenanes and rotaxanes) as well as container molecules (molecular capsules). The appealing prospect of also synthesizing these types of compounds with complex molecular architectures using reversible covalent bond forming chemistry has led to the development of DCC. Historically, DCC has played a central role in the development of conformational analysis by opening up the possibility to be able to equilibrate configurational isomers, sometimes with base (for example, esters) and sometimes with acid (for example, acetals). These stereochemical “balancing acts” revealed another major advantage that DCC offers the chemist, which is not so easily accessible in the kinetically controlled regime: the ability to re-adjust the product distribution of a reaction, even once the initial products have been formed, by changing the reaction's environment (for example, concentration, temperature, presence or absence of a template). This highly transparent, yet tremendously subtle, characteristic of DCC has led to key discoveries in polymer chemistry.

By using DCC, macromolecules and branched polymers of furfuryl alcohol can be created which retain the advantages of PF and FA foundry binders. These macromolecules and branched polymers of furfuryl alcohol also address the disadvantages of high viscosity, environmentally hazardous unreacted components and storage stability or shelf life associated with current PF and FA foundry binder systems, while providing sufficient reactivity to operate in the same manner as a known furfuryl alcohol binder. These adducts can be prepared as low viscosity liquids at room temperature and can be synthesized to contain less than 25 weight percent of free furfuryl alcohol.

Stated generally, the FAD product is prepared by reacting an aldehyde with furfuryl alcohol, preferably in the presence of a copper catalyst. The FAD product is isolated from the reaction products by separation methods such as distillation or column chromatography. In order to isolate FAD product having structure (A) from the reaction products, a distillation of the overall reaction product is followed by thin layer chromatographic (TLC) analysis. If resolution of distillation is not sufficiently satisfactory for separating the FAD product, then column chromatography can be used, the same stationary and mobile phase as performed during TLC analysis.

Monoaldehydes that may be useful in manufacturing the FAD product include, in addition to the aforementioned formaldehyde, acetaldehyde (CAS RN 75-07-0), propanal (CAS RN 123-38-6), butyraldehyde (CAS RN 123-72-8), benzaldehyde (CAS RN 100-52-7), cinnamaldehyde (CAS RN 104-55-2), and furfural (CAS RN 98-01-1).

Dialdehydes that may be useful include glyoxal (CAS RN107-22-2), succindialdehyde (CAS RN 638-37-9), glutaraldehyde (CAS RN 111-30-8), and phthaldialdehyde (CAS RN 643-79-8).

Polyaldehydes that may be useful in manufacturing the FAD product include poly(aldehyde guluronate) (“PAG”).

In producing the FAD product, the aldehydes are reacted in amounts such that the equivalent ratio of aldehyde to furfuryl alcohol is typically in the range of from 4:1 to 8:1 molar equivalents, and preferably from 4.05:1 to 4.25:1 molar equivalents.

Copper catalysts that are useful in preparing the FAD product copper II tetrafluoroborate and copper chloride. The copper catalyst is used in a catalytically effective amount, which is typically from 0.01 to 10 molar percent based upon the total weight of the furfuryl alcohol, preferably from 0.5 to 1 molar percent.

After completing the reaction, the pH of the reaction mixture is typically raised to 9 from 3 by adding an aqueous base. This precipitates the copper catalyst which is then removed, typically by filtration. Bases that can used to raise the pH include hydroxides, carbonates, and nitrogen containing bases. An endpoint for the reaction is typically determined by establishing the desired amount of unreacted furfuryl alcohol which is acceptable and monitoring the amount of unreacted unreacted furfuryl alcohol by gas chromatography. Typically, the accepted level of unreacted furfuryl alcohol will range from 5 to 25 weight percent based upon the total weight of the FAD product.

Compositions comprising the FAD product can be used to formulate warm-box, hot-box, cold-box, and no bake binder compositions. In order to accelerate the cure speed of the binder, it is desirable to add a curing catalyst to the binder composition. In general, any inorganic or organic acid, preferably an organic acid, can be used as a curing catalyst.

Typical curing catalysts used in the warm-box, hot-box process include latent acid salts such as ammonium chloride, ammonium nitrate, copper chloride, copper toluene sulphonate, aluminum phenol sulphonate and acids such as phenol sulphonic acid, p-toluene sulphonic acid (CAS RN 104-15-4), lactic acid (CAS RN 50-21-5), benzene sulfonic acid (CAS RN 98-11-3), xylene sulfonic acid, sulfuric acid and mixtures thereof. Particularly preferred curing catalysts used in the no-bake process are strong acids such as toluene sulfonic acid, xylene sulfonic acid, benzene sulfonic acid, hydrochloric acid, and sulfuric acid. Weak acid such as phosphoric acid can also be used in the no-bake process. For the cold-box process, a typical curing catalyst would be gaseous SO₂.

The amount of curing catalyst used is an amount effective to result in foundry shapes that can be handled without breaking. Generally, this amount is from 1 to 60 weight percent based upon the weight of total binder, typically from 10 to 40, preferably 15 to 35 weight percent. The catalyst may be mixed with appropriate diluents, e.g. water, alcohols, etc.

Foundry mixes are prepared by mixing a foundry aggregate with the binder composition. The aggregate used to prepare the foundry mix is that typically used in the foundry industry for such purposes or any aggregate that will work for such purposes. Generally, the aggregate is sand, which contains at least 70 percent by weight silica. Other suitable aggregate materials include zircon, alumina-silicate sand, chromite sand, and the like. Generally, the particle size of the aggregate is such that at least 80 percent by weight of the aggregate has an average particle size between 40 and 150 mesh (Tyler Screen Mesh).

The amount of binder composition used in the foundry mix is an amount that is effective in producing a foundry shape that can be handled or is self-supporting after curing. In ordinary sand type foundry applications, the amount of binder is generally no greater than about 10% by weight and frequently within the range of about 0.5% to about 7% by weight based upon the weight of the aggregate. Most often, the binder content for ordinary sand foundry shapes ranges from about 0.6% to about 5% by weight based upon the weight of the aggregate in ordinary sand-type foundry shapes.

Additives such as release agents, solvents, bench life extenders, silicone compounds, etc. can be used and may be added to the binder composition, aggregate, or foundry mix. Although not necessarily preferred, the binder could also contain other components including, for example, resorcinol, phenolic resin, urea, urea formaldehyde resins, melamine/urea/formaldehyde resins, melamine formaldehyde resins, polyvinyl acetate/alcohol, and polyols (e.g. polyether polyols, polyester polyols).

Curing is generally accomplished by filling the foundry mix into a pattern (e.g. a mold or a core box) to produce a workable foundry shape. In the hot-box and warm-box process preferably, the pattern is pre-heated to a temperature typically ranging from 150° C. and 300° C. A workable foundry shape is one that can be handled without breaking. Typically, the dwell time in the pattern is from 1 minute to 5 minutes. In the no-bake process, the pattern can be cold and the dwell time is dependent on the strength of the catalyst, the stronger the catalyst the shorter the dwell time. In the cold-box process, the foundry mix is filled into a pattern by using compressed air. This filled pattern is then gassed with SO₂ for a predetermined amount of time, usually from 10 to 30 seconds.

Metal castings can be prepared from the workable foundry shapes by methods well known in the art. Molten ferrous or non-ferrous metals are poured into or around the workable shape. The metal is allowed to cool and solidify, and then the casting is removed from the foundry shape.

### Preparation of the FAD Product

### EXAMPLE 1

A composition of the FAD product intended for use as a foundry binder was prepared by reacting an aldehyde with furfuryl alcohol in the presence of a catalyst. Specifically, glutaraldehyde, furfuryl alcohol and copper tetrafluoroborate were charged to an appropriately sized vessel, with the furfuryl alcohol and glutaraldehyde present in a mole ratio of 5.0:1.0. The catalyst is present in a mole ratio to furfuryl alcohol of 1:100. More specifically, 115.62 g of glutaraldehyde (0.58 mol), 283.82 g furfuryl alcohol (2.89 mol), and 1.37 g copper tetrafluoroborate (5.78 mmol) were charged to a 500 mL round bottom flask. The reaction mixture was allowed to stir for 24 hours at ambient temperature. After the reaction was complete, the pH of the reaction mixture was raised to 8.72 by adding a 50% aqueous sodium hydroxide solution to precipitate the copper catalyst. The precipitant was filtered out and the liquid passing through the filter was used for formulation. The reaction was deemed to be complete when the amount of unreacted furfuryl alcohol was below 25% by weight, based upon the total weight of the product. The amount of unreacted furfuryl alcohol was determined using gas chromatography.

### EXAMPLE 2

The protocol of Example 1 was repeated, except that the reaction was started at 50° C. and heat was applied to ramp the reaction temperature upwardly at a rate of 0.5° C./min until a temperature of 70° C. was reached. The reaction temperature was maintained at this level for 30 minutes, after which the mixture was allowed to cool to ambient. As in Example 1, the copper catalyst was separated by raising the pH and filtering out the precipitated catalyst. The liquid passing through the filter was used for formulation.

### EXAMPLE 3

The protocol of Example 2 was repeated, except that the mole ratio of furfuryl alcohol to glutaraldehyde was lowered to 4.31:1.0 by increasing the amount of glutaraldehyde from 115.62 g to 136.00 g, while using the same amounts of furfuryl alcohol and copper tetrafluoroborate. The resultant liquid was again used for formulation.

### Test Cores Made by the Hot-Box Process

The FAD reaction products of Examples 1 through 3 were used to prepare binder compositions. These binder compositions used the FAD product of the examples to replace the furfuryl alcohol in CHEM REZ™ 9972, a foundry binder commercially available from ASK Chemicals. To serve as a control, unmodified CHEM-REZ™ 9972 was used. After preparation, the viscosity of each binder composition was measured at 20° C., using a standard protocol. The viscosity of the control binder composition was less than 30 cP. The viscosities of the binder compositions using the Example 1 through 3 FAD reaction products were measured at 49.5 cP, 35.5 cP and 34.2 cP, respectively.

Test cores (“dog bones”) were made by mixing 1.0 part by weight of a selected binder composition (from the above examples and the control), as well as 0.25 parts by weight of CHEM REZ™ WB FC521 catalyst, commercially available from ASK Chemicals, with 100 parts by weight of BADGER 5574 sand, commercially available from Badger Mining Corporation (Berlin, Wis.) to form a foundry mix. The ingredients were blended in a suitable batch mixer until homogeneous. Each resulting foundry mix was then blown using compressed air into a metal pattern which had been pre-heated to a temperature of 250° C., to form a core. Each test core was allowed to reside in the pattern for a predetermined dwell time before it was removed. Dwell time was a variable used in assessing tensile strength.

Tensile strength tests were conducted on the test cores that were produced. First, a “hot” tensile strength measurement was conducted according to a standard protocol immediately after removal from the pattern. The measurement was repeated to obtain an average. Further test cores were made and allowed to cool for 2 hours before the same tensile strength measurement was performed, the results of which are designated below as the “cold” results. Yet further test pieces were made and allowed to cool for 24 hrs before the tensile strength measurement was made. The tensile strength was measured on cores having dwell times of 20, 30 and 40 seconds.

When the binder composition used to produce the test cores was the CHEM-REZ™ 9972 control composition, the following results were obtained:

| | Dwell time (sec) | | |
|---|---|---|---|
| | 20 | 30 | 40 |
| Hot | 51 psi | 68 psi | 68 psi |
| Cold | 584 psi | 631 psi | 602 psi |
| 24 Hrs | 528 psi | 536 psi | 539 psi |

In the next experiment, the binder composition used to produce the test cores was modified. Specifically, a binder composition was formulated in which the furfuryl alcohol component of the CHEM-REZ™ 9972 control composition was replaced by an equivalent amount of the FAD product as produced in Example 1. The FAD component had a free furfuryl alcohol content of less than 25%. The same tensile strength protocol was conducted, the following data were obtained:

| | Dwell time (sec) | | |
|---|---|---|---|
| | 20 | 30 | 40 |
| Hot | 39 psi | 78 psi | 78 psi |
| Cold | 344 psi | 329 psi | 330 psi |
| 24 Hrs | 330 psi | 294 psi | 272 psi |

When the binder composition was then changed to the FAD product of Example 3 and the test cores were produced, conducting the same test core tensile strength protocol provided these results:

| | Dwell time (sec) | | |
|---|---|---|---|
| | 20 | 30 | 40 |
| Hot | 49 psi | 56 psi | 56 psi |
| Cold | 294 psi | 289 psi | 286 psi |
| 24 Hrs | 243 psi | 242 psi | 226 psi |

These comparative data show that the binder prepared from the FAD product (Examples 1 and 3) can be used as a hot-box and warm-box process, although the FAD product has a free furfuryl alcohol level in the binder product that is significantly lower than that known in the prior art.

### Test Cores Made by No-Bake Process

As in the above method, test cores were made by mixing 1.0 part by weight of a control no-bake binder composition and 0.35 parts by weight of CHEM REZ™ Catalyst C-2006, a commercially available no-bake catalyst of ASK Chemicals, with 100 parts by weight of the BADGER 5574 sand to form a foundry mix. The control no-bake binder composition used had 95% by weight furfuryl alcohol, the balance being resorcinol and silane. In this case, however, each resulting foundry mix was then hand rammed into a metal pattern, at ambient temperature, to form a core. The core was formed within the work time (WT) of the mixed sand to ensure maximum strength. The core was allowed to reside in the pattern for to 15-20 minutes, unless otherwise specified, or until sufficiently strong that it could be removed without breaking, i.e., the strip time (ST). Tensile strengths of the test cores were measured at 1, 3 and 24 hours after preparation, at which time two measurements were made. In the first measurement, the test core was stored at ambient humidity conditions for 24 hours. In the second measurement, a test core stored for 24 hours at ambient conditions was placed in an environment maintained at 90% humidity for one additional hour before testing. This test is reported below as “24+1.” Although there was slight variation from case to case, the work times ranged from 3 to 5 minutes and the strip times ranged from 5 to 7 minutes.

This same process for preparing test cores and testing their tensile strength was repeated, using the FAD products from Examples 1 through 3 to replace the furfuryl alcohol in the control no-bake binder composition.

When the tensile strength tests were performed as described above, the following results were obtained for the no-bake binder compositions:

Time (hr)

| Binder | 1 | 3 | 24 | 24 + 1 |
|---|---|---|---|---|
| Control | 198 psi | 258 psi | 216 psi | 152 psi |
| Example 1 | 188 psi | 199 psi | 213 psi | 120 psi |
| Example 2 | 205 psi | 227 psi | 216 psi | 101 psi |
| Example 3 | 217 psi | 276 psi | 218 psi | 139 psi |

These data indicate that the cores prepared using the FAD product no-bake binder were comparable to or better than the cores prepared using the control no-bake binder.

### Test Cores Made by Cold-Box Process

As before, test cores were made by mixing 1.0 part of a binder and 0.4 parts by weight of INSTA-DRAW™ 1400 oxidizer catalyst, a product commercially available from ASK Chemicals, with 100 parts of the BADGER 5574 sand to form a foundry mix. The resulting foundry mix was then air blown into a metal pattern, at ambient temperature. The foundry mix was gassed with SO₂ while in the pattern to cure the test core. Tensile strengths of the cured test cores were measured at 0.5 minutes, 5 minutes, 60 minutes and 1440 minutes (24 hours) after preparation, with two measurements made at 24 hours. The first 24 hour measurement was based on storage at ambient humidity and the second was based on placing a test core stored at ambient conditions for 24 hours into a 90% humidity controlled environment for an additional hour. This latter situation is referred to below as “1440+60.” In the experiment, the control binder was INSTA-DRAW™, a commercially-available foundry core binder from ASK Chemicals and the FAD product binder was the one prepared in Example 3 above. The data from the tensile strength tests are as follows:

| | Time (min) | | | | |
|---|---|---|---|---|---|
| Binder | 0.5 | 5 | 60 | 1440 | 1440 + 60 |
| INSTA- | 116 psi | 180 psi | 216 psi | 237 psi | 155 psi |
| DRAW | | | | | |
| Example 3 | 89 psi | 119 psi | 153 psi | 176 psi | 117 psi |

These data show the applicability of the binder produced from the FAD product as a viable alternative to commercially-available products used as cold-box binders, such as INSTA-DRAW.

1. A compound of the structure:
X[—CH(OR)₂]ₘ (I)
wherein:
R is a 2-furfuryl group, a 2-(5-methylol) furfuryl group or a combination thereof,
m is in the range of from 1 to 5, and
X is an aliphatic, cycloaliphatic, aromatic or araliphatic group.

2. A process for making the compound of claim 1, comprising the step of:
reacting a furfuryl alcohol with an aldehyde in the presence of a copper catalyst, under conditions of dynamic covalent chemistry such that a resulting furfuryl alcohol derivative (“FAD”) composition contains less than 25 percent by weight of free furfuryl alcohol.

3. (canceled)

4. The process of claim 2, wherein:
the aldehyde is reacted with the furfuryl alcohol in an equivalent ratio in the range of from 4:1 to 8:1 molar equivalents.

5. The process of claim 2, wherein:
the copper catalyst is copper(II) tetrafluoroborate, copper chloride and mixtures thereof.

6. The process of claim 2, wherein:
the aldehyde is a monoaldehyde selected from the group consisting of: formaldehyde, acetaldehyde, propanal, butyraldehyde, benzaldehyde, cinnamaldehyde, and furfural.

7. The process of claim 2, wherein:
the aldehyde is a dialdehyde selected from the group consisting of: glyoxal, succindialdehyde, glutaraldehyde, and phthaldialdehyde.

8. The process of claim 2, wherein:
the aldehyde is poly(aldehyde guluronate).

9. A foundry mix, comprising:
a major amount of foundry aggregate; and
a binder, comprising the composition of claim 15.

10. The foundry mix of claim 9, further comprising:
a liquid curing catalyst, preferably selected from the group consisting of copper chloride, copper toluene sulphonate, aluminum phenol sulphonate, phenol sulphonic acid, p-toluene sulphonic acid, lactic acid, benzene sulfonic acid, xylene sulfonic acid, sulfuric acid, salts thereof and mixtures thereof.

11. The foundry mix of claim 10, wherein:
the liquid curing catalyst is present in an amount from about 1 to 60 weight percent, based upon the weight of the binder.

12. A “no-bake” process for forming a foundry shape, comprising the steps of:
introducing the foundry mix of claim 10 into a pattern to form a foundry shape;
allow the liquid curing catalyst present in the foundry mix to cure the formed foundry shape until the formed foundry shape is sufficiently cured to be handleable; and
removing the formed and cured foundry shape from the pattern.

13. A “cold box” process for forming a foundry shape, comprising the steps of:
introducing the foundry mix of claim 9 into a pattern to form a foundry shape;
contacting the formed foundry shape with a vaporous curing catalyst capable of curing the formed foundry shape until the formed foundry shape is sufficiently cured to be handleable; and
removing the formed and cured foundry shape from the pattern.

14. A “hot box” process for forming a foundry shape, comprising the steps of:
introducing the foundry mix of claim 10 into a pattern to form a foundry shape;
allow the liquid curing catalyst present in the foundry mix to cure the formed foundry shape until the formed foundry shape is sufficiently cured to be handleable; and
removing the formed and cured foundry shape from the pattern.

15. A composition, comprising:
a phenolic resin; and
a furfuryl alcohol derivative (“FAD”), having free furfuryl alcohol content of less than 25% by weight, having a structure:
X[—CH(OR)₂]ₘ
wherein:
R is a 2-furfuryl group, a 2-(5-methylol) furfuryl group or a combination thereof,
m is in the range of from 1 to 5, and
X is an aliphatic, cycloaliphatic, aromatic or araliphatic group.
